(19) United States
(12) Patent Application Publication
(10) Pub. No.: US 2015/0282577 A1
(43) Pub. Date: Oct. 8, 2015

(54) ADJUSTABLE CANE GRABBER

(71) Applicant: Steven Oliphant, Midlothian, TX (US)

(72) Inventor: Steven Oliphant, Midlothian, TX (US)

(21) Appl. No.: 14/247,731

(22) Filed: Apr. 8, 2014

(51) Int. Cl. A45B 9/00; B25J 1/04

(52) U.S. Cl. CPC A45B 9/00; B25J 1/04; A45B 2009/007

(57) ABSTRACT

An adjustable cane grabber comprising an elongated body, where the elongated body separates between an upper tubular portion and a lower tubular portion, where the lower tubular portion adjustably receives the upper tubular portion; an articulating hand at a lower end of the upper tubular portion, where the articulating hand is received into the lower tubular portion, and where the articulating hand grasps an object for a user; a pair of arms within the articulating hand, where the pair of arms open and close around the object; a handle at an upper end of the upper tubular portion; and an actuator attached to the handle, where the actuator is also coupled to the pair of arms.

### BACKGROUND OF THE INVENTION

1. Field of the Invention

The present invention relates to a device that serves as both a walking can and a grabbing device to assists cane users to grasp items out of their immediate reach.

2. Description of Related Art

A walking cane is one of the most universal aids used by the elderly to help them balance and maneuver from one place to another. Additionally, individuals who may have weak legs either from surgery, injury, illness or the like may utilize a walking cane until their legs regain their full strength. Walking canes may range from the most basic, hospital issued cane to a decorative walking piece appreciated not only for its functional use but also for its craftsmanship. Either way these tools are necessary balance devices that support the user while standing and ensure that their balance is maintained while moving.

Another helpful tool is a grabber or reaching aid. These devices provide an extension to the user's arm enabling them to obtain objects out of their immediate reach. The grabbers typically have an articulating hand which grasps the desired object. The articulating hand is controlled by a mechanical handle to open and close the hand. These grabbers may be especially useful to elderly or injured individuals unable to bend or reach.

Because of the usefulness and shared users, it would be beneficial in the art to provide a tool that both helps to balance a user while also providing assistance to grab out of reach objects. It would also be desirable in the art to provide a tool that easily accommodates more than one user with the same tool.

### SUMMARY OF THE INVENTION

In view of the foregoing disadvantages inherent in the prior art, the general purpose of the present invention is to provide a combination walking cane and grabbing device, configured to include all of the advantages of the prior art, and to overcome the drawbacks inherent therein.

Accordingly, an object of the present invention is to provide an adjustable cane grabber which combines a walking cane with a grabber device.

Another object of the present invention is to provide an adjustable cane grabber where the length is adjustable to allow use by users of varying heights.

To achieve the above objects, in an aspect of the present invention, an adjustable cane grabber is described comprising an elongated body, where the elongated body separates between an upper tubular portion and a lower tubular portion, where the lower tubular portion adjustably receives the upper tubular portion; an articulating hand at a lower end of the upper tubular portion, where the articulating hand is received into the lower tubular portion, and where the articulating hand grasps an object for a user; a pair of arms within the articulating hand, where the pair of arms open and close around the object; a handle at an upper end of the upper tubular portion; and an actuator attached to the handle, where the actuator is also coupled to the pair of arms.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of an adjustable cane grabber in accordance with an exemplary embodiment of the present invention; and

FIG. 2 depicts a perspective view of a detached adjustable can grabber in accordance with an exemplary embodiment of the present invention.

Like reference numerals refer to like parts throughout the description of several views of the drawings.

### DETAILED DESCRIPTION OF THE DRAWINGS

The present invention relates to a device that serves as both a walking can and a grabbing device to assists cane users to grasp items out of their immediate reach. The present invention provides an adjustable cane grabber to offer a walking cane that simultaneously acts as a clamping device to assist a user with grasping items out of reach. The adjustable cane grabber includes a walking cane with a detachable handle that is also a gripping device. The adjustable cane grabber may be adjustable to different lengths to accommodate any user, which enables use between multiple users for a single cane.

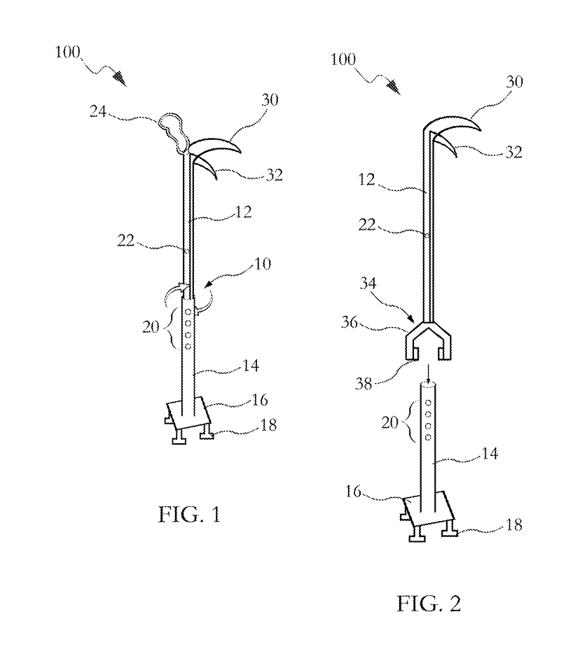

Turning now descriptively to the drawings, referring to FIG. 1, an adjustable cane grabber 100 is shown in accordance with an exemplary embodiment of the present invention. The adjustable cane grabber 100 includes an elongated body 10 composed of two pieces, an upper tubular portion 12 and a lower tubular portion 14. The upper tubular portion 12 may comprise a grabber portion of the adjustable cane grabber 100. The lower tubular portion 14 receives the upper tubular portion 12 and is secured in place with a telescopic lock 20, 22. The telescopic lock includes a plurality of holes 20 positioned vertically along the lower tubular portion 14 to receive a button 22 on the upper tubular portion 12. The telescopic lock 20, 22 enables the length of the elongated body 10 to be adjusted as necessary by the user. The upper tubular portion 12 may twist into the lower tubular portion 14 when adjusting and locking the telescoping lock 20, 22. The elongated body 10 may be made from a lightweight material like plastic or aluminum to ensure durability without excessive weight.

At a bottom portion of the lower tubular body 14 is a base 16. The base 16 stabilizes and supports the elongated body 10 to remain erect when not being held by the user. The base 16 may comprises a generally square shape to provide the user with a wide support upon which they may comfortably rest their weight. Beneath the base 16 may be a set of feet 18 to grip the underlying floor or ground. The feet 18 may be rubber extensions or lifts to prevent the adjustable cane grabber 100 from slipping and sliding during use.

At a top portion of the upper tubular portion 12 may be a strap 24. The strap 24 allows the user to secure the upper tubular portion 12 to their hand or wrist, thereby preventing dropping. The strap 24 may be made from elastic, leather, rubber, and may include a closure to adjustably fasten the strap 24 to the user. The closure may be a hook and loop fastener, a snap, a buckle or the like. Next to the strap 24 is a handle 30. The handle 30 is supportive to the user while pressing their weight against the elongated body 10. The handle 30 includes an actuator 32 to control the grabber, which will be described in greater detail in reference to FIG. 2. The handle 30 may be padded for a non-slip, ergonomic grip therefore providing a comfortable feel against the user's hand. Furthermore, the handle 30 may be decorative with decorative shapes and designs as preferred by the user.

Referring now to FIG. 2 a perspective view of the adjustable cane grabber 100 is shown with the upper tubular portion 12 detached from the lower tubular portion 14. By pressing the button 22 the upper tubular portion 12 detaches from the lower tubular portion 14 to separate the elongated body 10 into its two components. This way the grabber 12 may be used independently while the lower tubular portion 14 stands erect until needed again by the user.

At the lower end of the upper tubular portion 12 is an articulating hand 34 which inserts into the lower tubular portion 14 during use as a walking cane. The articulating hand 34 enables the user to grasp items out of their reach. The articulating hand 34 includes a pair of arms 36 which open and close using the actuator 32. To close the pair of arms 36 the actuator 32 is pressed against the handle 30. Accordingly, to open the pair of arms 36 the actuator 32 is released thereby releasing the object obtained within the articulating hand 34. The pair of arms 36 includes grips 38 which are rubberized pads that secure whatever object grasped between the arms 36 to ensure that it does not slide or drop from the articulating hand 34.

With the adjustable cane grabber 100 a walking cane and a grabber are combined into a single, multi-purpose tool. The elongated body 10 is especially convenient because of its ability to adjust to different heights in order to suit individual needs. The adjustable cane grabber 100 is a unique tool combining the functions of a grasping device with a walking cane, ultimately providing a device capable of reaching and grabbing items with ease and less overall strain.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

1. An adjustable cane grabber comprising:
a. an elongated body, where the elongated body separates between an upper tubular portion and a lower tubular portion, where the lower tubular portion adjustably receives the upper tubular portion, where the upper tubular portion is adjustable with a telescopic lock within the lower tubular portion and the telescopic lock includes a plurality of holes along the lower tubular portion which receive a button on the upper tubular portion to adjust a length of the elongated body and the upper tubular portion functions as a grabber when attached to the lower tubular portion, and the upper tubular portion and lower tubular portion function as a walking cane when joined together;
b. an articulating hand at a lower end of the upper tubular portion, where the articulating hand is received into the lower tubular portion, and where the articulating hand grasps an object for a user;
c. a pair of arms within the grabber, where the pair of arms open and close around the object;
d. a handle at an upper end of the upper tubular portion; and
e. an actuator attached to the handle, where the actuator is also coupled to the pair of arms.

2. (canceled)

3. (canceled)

4. The adjustable cane grabber according to claim 1, where the telescopic lock enables the upper tubular portion to twist into place within the lower tubular portion.

5. The adjustable cane grabber according to claim 1, where the lower tubular portion includes a base at a bottom portion, where the base supports the elongated body to remain erect.

6. The adjustable cane grabber according to claim 5, where the base includes a set of feet to prevent the elongated body from sliding.

7. The adjustable cane grabber according to claim 1, where the upper tubular portion includes a strap.

8. The adjustable cane grabber according to claim 1, where the pair of arms closes when the actuator is pressed against the handle, and where the pair of arms opens when the actuator is released.

9. The adjustable cane grabber according to claim 1, where the pair of arms includes grips.

10. An convertible walking cane comprising:
a. an elongated body, where the elongated body separates between an upper tubular portion and a lower tubular portion, where the lower tubular portion adjustably receives the upper tubular portion, where the upper tubular portion is adjustable with a telescopic lock within the lower tubular portion and the telescopic lock includes a plurality of holes along the lower tubular portion which receive a button on the upper tubular portion to adjust a length of the elongated body;
b. an articulating hand at a lower end of the upper tubular portion, where the articulating hand is received into the lower tubular portion, and where the articulating hand grasps an object for a user;
c. a handle at an upper end of the upper tubular portion;
d. an actuator attached to the handle, where the actuator is also coupled to the pair of arms;
e. a base at a bottom portion, where the base supports the elongated body to remain erect
f. a first position, where the upper tubular portion is joined to the lower tubular portion, and the walking cane functions solely as a walking cane; and
g. a second position, where the upper tubular portion is separated from the lower tubular portion, and the upper tubular portion functions as a grabber
